(19) United States
(12) Patent Application Publication
(10) Pub. No.: US 2021/0397663 A1
(43) Pub. Date: Dec. 23, 2021

(54) DATA REDUCTION IN A TREE DATA STRUCTURE FOR A WIREFRAME

(71) Applicant: Neural Technology Limited, Cheshire (GB)

(72) Inventors: Tim de Paris, London (GB); Branden Ray McClain, London (GB); Mohammad Haque, London (GB)

(21) Appl. No.: 17/349,618

(22) Filed: Jun. 16, 2021

(30) Foreign Application Priority Data
Jun. 17, 2020 (GB) 2009263.1

(51) Int. Cl. G06F 16/958; G06F 16/901

(52) U.S. Cl. CPC G06F 16/958; G06F 16/9027

(57) ABSTRACT

A second tree data structure (“second tree”) is formed from a first tree data structure (“first tree”). The first tree relates to a displayable page. The second tree relates to a displayable wireframe of the page. A method comprises: for each node in the first tree, determining if the node meets at least one predetermined node type rule (B, 312); and based at least on a result of the determining, including the node, in the second tree (E, 328, 330).

### PRIORITY CLAIM

This application claims a benefit and priority to a United Kingdom Application No. 2009263.1, filed on Jun. 17, 2020, the content of which is herein incorporated by reference in its entirety.

### Field of the Invention

The invention relates to a method of forming a second tree data structure from a first tree data structure, the first tree data structure relating to at least one displayable page, and the second tree data structure relating to a displayable wireframe of the at least one page.

### BACKGROUND

Wireframes of websites and applications may be useful to various parties. Developers, designers, information architects and business analysists may use wireframes with a view to understanding functionality of a website, user experience and to understand navigation paths between pages and to visually support interaction requirements. Wireframes may also be reviewed to ensure that objectives are met through a design. Wireframe generation is time consuming. It is an object of the present invention to provide a way of generating wireframes of websites or applications having underlying tree data structures.

### SUMMARY OF THE INVENTION

According to a first aspect of the present invention, there is provided a method of forming a second tree data structure (“second tree”) from a first tree data structure (“first tree”), the first tree relating to at least one displayable page, and the second tree relating to a displayable wireframe of the at least one page, the method comprising: for each node in the first tree, determining if the node meets a predetermined node type rule; and dependent at least on a result of the determining, including the node in the second tree.

The determining if the node meets the at least one node type rule may comprise determining a type for the node based on at least one character string in the node, and determining that the node meets the at least one predetermined node type rule if the determined type is permitted by the at least one node type rule.

The method may further comprise, if the node meets the node type rule, determining if the node meets at least one predetermined appearance rule relating to a visual aspect of the node on the displayable page. In this case the including of the node in the second tree is also dependent on a result of the determining if the node meets the at least one appearance rule.

The determining if the node meets the at least one appearance rule may comprise determining if one or more of the following requirements are met:
a) the node corresponds to a visible element in the at least one page;
b) the node includes width and/or height information for the element on the page;
c) the node is not fully transparent;
d) the size and position of the node is not the same size and position as a parent of the node.

The method may further comprise, if the node meets the at least one appearance rule, removing data from the node dependent on at least one data modification rule. For example, PII may be removed.

The at least one data modification rule may require that, if data of at least one predetermined type is present in the node, the data is removed. The data of the at least one predetermined type may be one or more of:
a) a data attribute;
b) an URL and/or hypertext reference in the code of the node;
c) an attribute that does not relate to visual representation;
d) text.

The including the node in the second tree may comprise adding the node according to at least one node addition rule. The at least one node addition rule may require:
(i) where one of the nodes in the second tree corresponds to a parent of the node in the first tree, the node is added as a child node of the one node;
(ii) where a node corresponding to the parent of the node in the first tree is absent, the node is added as a child node of a next lowest parent node in the second tree.

The processing of the nodes of the first tree may be ordered such that the processing is performed for a node before the processing is performed for any descendant node.

The processing of the nodes of the first tree may be performed using a pre-order depth-first traversal approach.

The first tree may be formed from a first HTML or XML document.

The method may further comprise forming a document based on the second tree.

According to a second aspect of the present invention, there is provided a computer program product for forming a second tree from a first tree, comprising a computer readable storage medium having program instructions embodied therewith, the program instructions executable by a device to cause the device to perform steps of: for each node in the first tree, determining if the node meets a predetermined node type rule; and dependent at least on a result of the determining, including the node in the second tree, wherein the first tree relates to at least one displayable page, and the second tree relates to a displayable wireframe of the at least one page.

According to a third aspect of the present invention, there is provided a data processing apparatus for forming a second tree from a first tree comprising at least one processor and at least one memory having a processing module stored thereon, wherein the at least one processor with the memory and the processing module are configured to perform steps of: for each node in the first tree, determining if the node meets a predetermined node type rule; and dependent at least on a result of the determining, including the node in the second tree, wherein the first tree relates to at least one displayable page, and the second tree relates to a displayable wireframe of the at least one page.

According to a fourth aspect of the present invention, there is provided a method of forming a second tree data structure (“second tree”) from a first tree data structure (“first tree”), wherein the first tree relates to at least one displayable page, and wherein the second tree relates to a displayable wireframe of the at least one page, the method comprising: for the or each node in the first tree, determining if the node meets at least one data modification rule based on the node including data of a predetermined type; if the rule is met, removing the data of the predetermined type from the node; and including the node with the removed data in the second tree.

### BRIEF DESCRIPTION OF FIGURES

For better understanding of the present invention, embodiments will now be described, by way of example only, with reference to the accompanying Figures in which:

FIG. 1 is a block diagram indicating elements involved in implementation of an embodiment of the present invention;

FIG. 2 is a table indicating character strings in nodes that indicate that the node is a predetermined node type;

FIG. 3 is a flowchart indicating steps in carrying out embodiments of the invention;

FIG. 4 is an example wireframe; and

FIG. 5 is an example of a node in the second tree;

FIG. 6 is a flowchart indicating steps in generating an HTML document from a second tree.

### DETAILED DESCRIPTION OF EMBODIMENTS

Embodiments of the invention relate to generating a second tree data structure (“second tree”) from a first tree data structure (“first tree”). The first tree can be processed to display a first page. The second tree can be processed to display a second page, where the second page is a wireframe of the first page. Thus, the generating the second tree comprises converting the first tree to the second tree using a process that removes data that is not wanted or required for the second page.

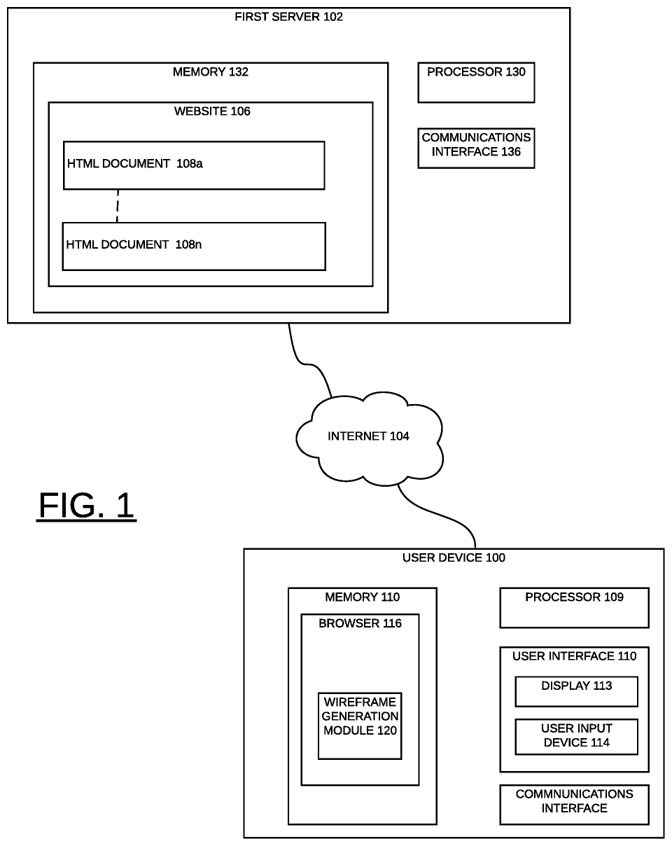

Referring to FIG. 1, embodiments of the invention may be implemented in an environment in which a user device 100 and a server 102 are both coupled to the internet 104. The server 102 hosts a website 106 including at least one webpage. An HTML document 108a-n for each webpage is stored at the server 102.

The user device 100 includes a processor 109, a memory 110, a user interface 111 and a communications interface 112, operatively coupled with a bus (not shown). The user device 100 may be in the form of a personal computer, a laptop, a smart phone, for example. The user interface includes a display 113 and a user input device 114, for example a keyboard and mouse, or the display 113 and the user input device 114 are provided by a touch screen, for example. Embodiments are not limited to any particular form of user device or user interface.

One or more computer programs are stored in the memory 110 and run on the user device 100. One such program is a web browser 116 configured to enable requesting of webpages, receiving of HTML documents for requested webpages, and processing of the HTML documents to display pages on the display 113. Another such program is a wireframe generation module (“module”) 120, which is a plug-in (or extension or add-on) for the browser 116.

Each HTML document 108a-n has an inherent tree data structure. In the Document Object Model (DOM) each of the HTML documents is viewed as a first tree. Embodiments of the invention relate to converting one or more of the HTML documents 108a-n to a respective modified HTML document, which includes converting the first tree of the HTML document 108a-n to a second tree for the modified HTML document.

The first and second trees comprises nodes. The nodes comprise branch nodes and leaf nodes. The branch nodes each have at least one child node, which may be one or more leaf nodes, and include a root node and typically intermediate nodes between the leaf nodes and the root node.

To convert the first tree to the second tree, the wireframe generation module 120 is configured to process each node of the first tree in the DOM in sequence and, for each node, make one or more decisions, based on rules, on whether a corresponding node is to be added to the second tree. When one of the nodes is to be added to the second tree, the wireframe generation module 120 may also process the node of the first tree to remove data before the corresponding node is added to the second tree.

In this disclosure the root node is considered to be at the top of the tree and the leaf nodes are considered to be at the bottom. The words “top”, “bottom”, “above”, “below”, “higher” and “lower” should be construed accordingly. The terms “parent”, “child” and “sibling” are used herein to refer to relationships between nodes where a node is, respectively, next above, next below and shares the same parent as another node.

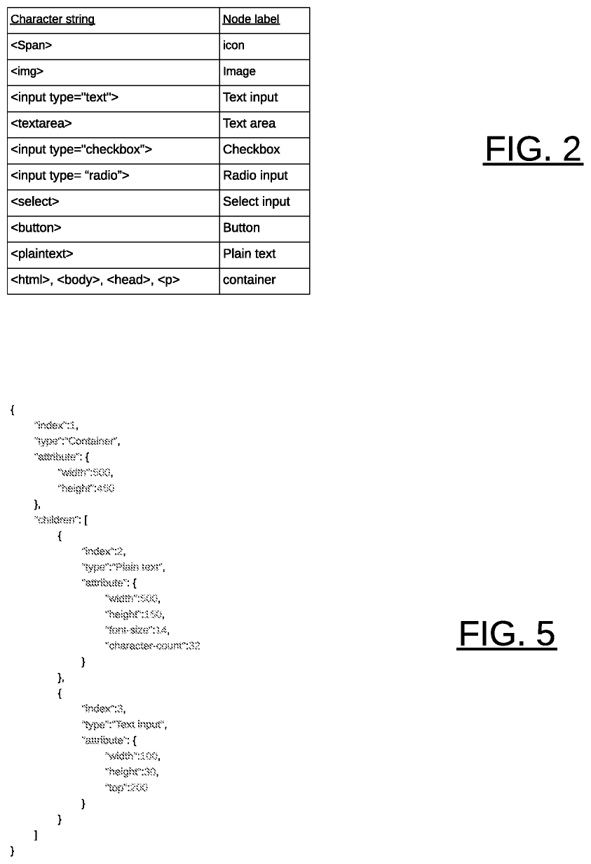

In order to determine whether each node is to be added to the second tree, the module 120 is configured to apply node type rules to determine if the node is one of a plurality of predetermined node types. FIG. 2 lists in its left column a plurality of character strings that may appear within code of nodes that serve to identify node types. The predetermined node types are those for nodes that may be relevant to generation of a wireframe and the module 120 is configured to filter candidate nodes from non-candidate nodes.

FIG. 2 lists in its right column node type labels as defined in the wireframe generation module 120. The labels may be otherwise defined. More than one character string may map to each label. For example, where <html>, <body>, <head>and <p> are present in the code of a node, the node is assigned a “container” label.

If none of the node type rules is met, the module 120 is configured to ignore the node and move on to the next node in the sequence. If one of the node type rules is met, the wireframe generation module 120 is configured to determine that the node is a candidate node for adding to the second tree. In variant embodiments, the module 120 may determine that the node is to be added to the second tree based solely on whether one of the node type rules is met.

Embodiments of the invention are not limited to the rules indicated in FIG. 2, that is, to where only the nodes of the first tree of the predetermined types are candidate nodes for adding to the second tree. In variant embodiments additional node type rules may be specified in accordance with which nodes of other types are determined to be candidate nodes for adding to the second tree. Such an additional node type rule may map one or more predetermined character strings other than those set out in FIG. 2 to one or the labels in FIG. 2, or a further one or more labels may be defined to which character strings are mapped. Embodiments are also not limited to including all of the rules indicated in FIG. 2.

Some or all nodes each also have at least one attribute associated with it relating to a visual aspect of how the corresponding element appears in the first page. Such an attribute may be any one of the following attributes: element width; element height; a position in a CSS “top” property; a position in a CSS “bottom” property; font size of text for display in the element; CSS font weight property; CSS text alignment property; character count. Embodiments are not limited to nodes including any one or more such attributes. One or more alternative attributes may be present and any one of more of the mentioned attributes may be absent.

The module 120 is also configured to apply appearance rules to the candidate nodes relating to appearance of the nodes to the user. Applicability of each appearance rule may be dependent on any of the attributes associated with the node that relate to a visual aspect. The appearance rules are configured so that the candidate nodes that are not relevant to a wireframe are excluded from the second tree. Embodiments of the invention are not limited to inclusion of any particular appearance rules. The appearance rules may all be applied to each candidate node, or one or more of the appearance rules may be applied dependent on the determined node type of the node. Thus, different appearance rules may be specified for candidate nodes of different types; a first set of the appearance rules may be applicable for candidate nodes of a particular type, whereas a second set of the appearance rules may be applicable for candidate nodes of another one of the types.

By way of example, one of the appearance rules may specify that the candidate node must correspond to an element that is visible in the corresponding web page in order for the candidate node to be permitted to be included in the second tree. If the node does not, the candidate node is not added to the second tree.

Another appearance rule may be that the candidate node must include width and/or height information for a corresponding element that is visible in the corresponding web page in order for the node to be permitted to be included in the second tree. If the node does not, the candidate node is not added to the second tree.

Another appearance rule may be that the candidate node must not be fully transparent in order for the node to be permitted to be included in the second tree. If the candidate node is fully transparent, the candidate node is not added to the second tree.

Another appearance rule may be that the size and position of the node must not be the same size and position as a parent of the node. If this is the case, the candidate node is not added to the second tree.

After the appearance rules have been applied, the module 120 is also configured to apply data modification rules to exclude or remove data from nodes to be added to the second tree. Applying of each data modification rule comprises determining if a predetermined type of data is present, and, if so, removing that data from that node. One of more of the nodes may not require such removal of data.

In an example of one of the data modification rules, the data type is a data attribute associated with the node. If a data attribute is present, it is removed from the node.

In another example, the data type is an URL and/or hypertext reference. If such is present, it is removed from the node.

In another example a rule requires that any attribute that does not relate to visual representation is removed. For example, a node may be represented as “<textarea rows=“4” cols=“50” minlength=“2” maxlength=“500”>” In this case the “rows” and “cols” attributes are retained as they have visual significance and the “minlength” and “maxlength” attributes are removed as they do not have any visual significance when the DOM is reconstructed.

Another example of such a rule requires that any text that is visible on the first display is removed.

The module 120 is configured to add the node to the second tree according to at least one node addition rules. The node addition rules require:
(i) if one of the nodes in the second tree corresponds to a parent of the node in the first tree, the node is added as a child node of that node;
(ii) if a node corresponding to the parent of the node in the first tree is absent, the node is added as a child node of the next lowest parent node in the second tree.

The module 120 is configured to process each node of the first tree in sequence using selection rules, for example implemented using a pre-order depth-first traversal algorithm. The processing of the nodes of the first tree is ordered such that the processing is performed for a node before the processing is performed for any descendant node.

In different embodiments, both the node type rules, the appearance rules and the data modification rules can be configured to result in the wireframe having different degrees of detail. A user interface may be provided enabling individual rules to be turned on and off

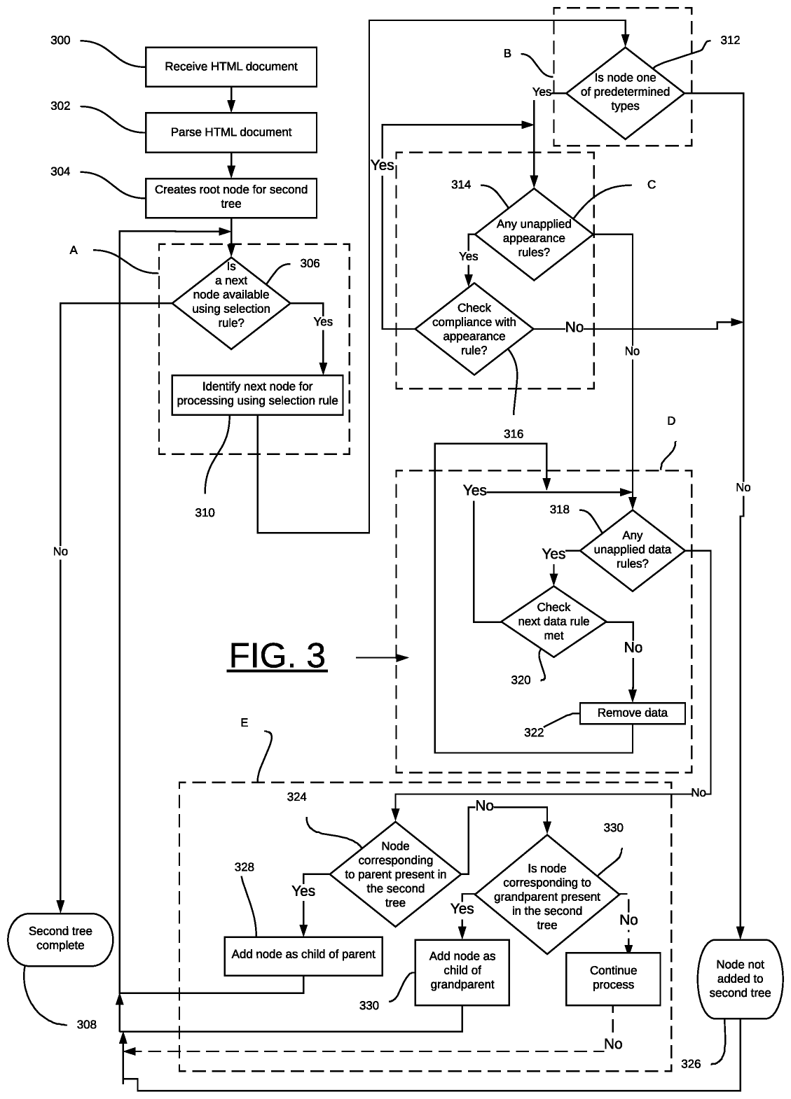

Operation of the invention in accordance with embodiments is now described with reference to FIG. 3. First the module 120 receives the HTML document for processing at step 300 and parses it at step 302. The wireframe generation module 120 then creates a root node for the second tree at step 304, or alternatively loads a template including a root node to which nodes can be added. In outline the following general steps are then performed. At general step A, a next node for processing is selected using the selection rules. At general step B, the node type rules are applied to determine if the node is a candidate node for adding to the second tree. At general step C, if the node is a candidate node, the appearance rules are applied to determine if the node is to be added to the second tree or discarded. At general step D, if the candidate node is to be added, the data modification rules are applied and, if appropriate, data is removed from the node in accordance with the rules. At general step E, the node, which may now be modified in accordance with the data modification rules, is added to the second tree in accordance with the node addition rules. Logical steps involved in steps A to E are now described in greater detail.

At general step A, using the selection rules, the module 120 first determines if there remains any node to be processed at step 306. If there is, the module 120 selects the next node for processing. Otherwise, the second tree is determined to be complete (step 308).

At general step B, the module 120 then determines if the node is one of the predetermined node types at step 312 by determining if the node is a match with each of the predetermined node types in turn until either one of the node types is matched to or until it is determined that the node does not match with any of the node types. This is performed by determining whether any character string in the node matches with one of the predetermined character strings. For example a <script> node will not match with any of the node types since a <script> node is not in the left column in FIG. 2. If the node does not match to any of the node types, the processing of the node ends, such that the node is not added to the second tree (308). In this case, the process returns to step 306.

At general step C, where a node is matched to at step 312, the module 120 then determines if any of the appearance rules have not yet been applied to the candidate node. If not, a next of the appearance rules is applied at step 316. If any of the appearance rules are not complied with, the candidate node is not added (step 326) to the second tree and the process returns to step 306.

At general step D, where all of the appearance rules are met, the module 120 then determines at step 318, if any of the data modification rules have not yet been applied to the node. If not, a next of the data modification rules is applied at step 320. If that data modification rule is met, the next of the rules is then applied. If any one of these rules are not met due to presence of particular data in the node, the module 120 removes such data from the processed node at step 322.

At general step E, the module 120 determines at step 324 if a higher node corresponding to the parent of the node in the first tree is present in the second tree. If so, the processed node is added as a child of that higher node at step 328. Otherwise, the module 120 determines, in accordance with the node addition rules, if a higher node corresponding to the grandparent of the node in the first tree is present in the second tree at step 330. If so, the processed node is added as a child of that node at step 332. If no such node is present, higher ancestor nodes are looked for in a repetition of such steps for each next higher node until a node is found to which the processed node is added as a child node.

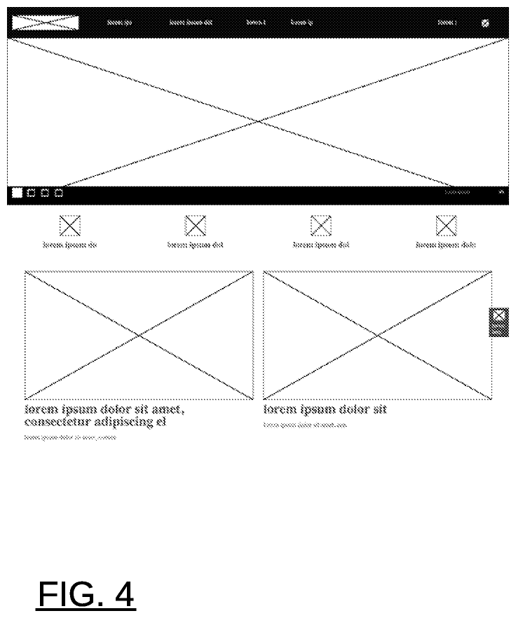

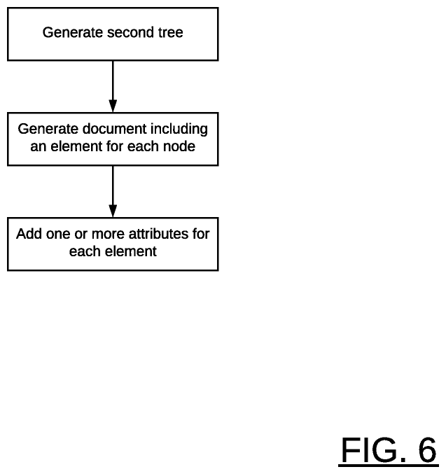

After the second tree has been generated, the module 120 generates an HTML document using the second tree. FIG. 4 is an example of such a document. Referring to FIG. 6, in order to generate the document, code for HTML elements is generated and attributes are applied to each of the HTML elements based on the node type indicated in FIG. 2, in accordance with yet further rules. The attributes are standardised for the wireframe. For example, where the node type was “icon”, the attribute is added with a reference to a stock image stored in the module 120 (shown as a “X” in FIG. 4). Where sample text (e.g. “Lorem Ipsum . . . ” text) is to be added, the character count is specified as an attribute and the character count is used to generate such text.

Using the above described process, webpage information can be collected in the second tree for later reproduction in a second page and the second tree will not collect any personally identifiable information as no text, image, URL or any other personal data is collected. Additionally, by conversion of HTML documents from several websites into second HTML documents, comparison is facilitated since wireframes provide a consistent way of representing multiple visual layouts on a computer screen in a highly transportable and flexible way.

Embodiments of the invention are not limited to conversion of HTML documents to modified HTML documents. The computer programs stored in the memory 110 may include an application that produce a displayed data (for example, text, graphics and layout) on the screen. Such an application may be provided in addition to or alternatively to the browser 116. A document that is processed to produce the displayed data and the code in this document may be in XML (Extensible Markup Language). XML documents can be interpreted as a tree structure. Although conversion of DOM trees for HTML documents is described above, principles of the invention can be applied analogously to conversion of XML trees with data conversion.

In the embodiments, the wireframe generation module 120 is provided as an extension to the browser or otherwise at the user device 100. However in other embodiments the wireframe generation module 120 may be located at a server (either the server 102 or another server), and the conversion of the first tree to the second tree may take place at the server. The second document can be sent to the user device 100 for display.

The first server 102 may each be implemented using a general-purpose computing device. Such a computing device may include one or more processors 130, a memory 132 (typically comprising at least a system memory and a secondary memory) and a communications interface 136, all coupled by a bus (not shown). Multiple computing devices may be used to implement the described functionality; for example, software components running on a variety of different computing devices may collaborate to provide the functionality.

Instructions executable to perform steps of embodiments of the invention may be stored in the memory 132. The one or more processors 130 may be any type of processor suitable for execution of such instructions, including but not limited to a general-purpose digital signal processor or a special purpose processor. In some embodiments, electronic circuitry including, for example, programmable logic circuitry, field-programmable gate arrays (FPGA), or programmable logic arrays (PLA) may execute the instructions by utilizing state information of the instructions to personalize the electronic circuitry, in order to perform aspects of the present invention.

The memory may be implemented using any suitable memory technology. A system memory may include RAM or other dynamic, volatile storage (e.g. SDRAM, DDR SDRAM, RDRAM, SRAM, etc.), and ROM or other non-volatile memory (e.g. PROM, EPROM, EEPROM, Flash memory), for storing data and instructions for execution by the one or more processors 130. Typically, the computing device includes an operating system (OS) stored in the non-volatile memory. A secondary memory may include, for example, a hard disk drive and/or a removeable storage device by which removable storage media can be accessed. The term “memory” is used herein to refer to any physical component that can retain or store instructions and data on a temporary or permanent basis. Instructions and data are stored in the system memory and/or the secondary memory and are accessible by the one or more processors 132 and enable the computing device to implement embodiments of the present invention as described herein.

The communications interface 136 allows software and data to be transferred between the computer device and external devices, via a local network or via the internet or other network. The communications interface may support communication via any suitable wired or wireless general data networks, such as types of Ethernet network, telecommunications/telephony networks, for example, or via any other suitable type of network and/or protocol.

Aspects of the present invention are described herein with reference to flowchart illustrations and/or block diagrams of methods, apparatus (systems, and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or can be carried out by combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

1. A method of forming a second tree data structure (“second tree”) from a first tree data structure (“first tree”), the first tree relating to a displayable page, and the second tree relating to a displayable wireframe of the page, the method comprising:
for each node in the first tree, determining if the node meets at least one predetermined node type rule; and
dependent at least on a result of the determining, including the node in the second tree.

2. The method of claim 1, wherein the determining if the node meets the at least one node type rule comprises:
determining a type for the node based on at least one character string in the node, and determining that the node meets the at least one predetermined node type rule if the determined type is permitted by the at least one node type rule.

3. The method of claim 1, further comprising:
if the node meets the node type rule, determining if the node meets at least one predetermined appearance rule relating to a visual aspect of the node on the displayable page;
wherein the including of the node in the second tree is also dependent on a result of the determining if the node meets the at least one appearance rule.

4. The method of claim 3, wherein the determining if the node meets the at least one appearance rule comprises determining if one or more of the following requirements are met:
a) the node corresponds to a visible element in the at least one page;
b) the node includes width and/or height information for the element on the page;
c) the node is not fully transparent;
d) the size and position of the node is not the same size and position as a parent of the node.

5. The method of claim 1, further comprising:
if the node meets the at least one appearance rule, removing data from the node dependent on at least one data modification rule.

6. The method of claim 5, wherein the at least one data modification rule requires that, if data of at least one predetermined type is present in the node, the data is removed.

7. The method of claim 6, wherein the data of the at least one predetermined type is one or more of:
a) a data attribute;
b) an URL and/or hypertext reference in the code of the node;
c) an attribute that does not relate to visual representation;
d) text.

8. The method of claim 1, wherein the including the node in the second tree comprises adding the node according to at least one node addition rule.

9. The method of claim 8, wherein the at least one node addition rule requires:
(i) where one of the nodes in the second tree corresponds to a parent of the node in the first tree, the node is added as a child node of the one node;
(ii) where a node corresponding to the parent of the node in the first tree is absent, the node is added as a child node of a next lowest parent node in the second tree.

10. The method of claim 1, wherein the processing of the nodes of the first tree is ordered such that the processing is performed for a node before the processing is performed for any descendant node.

11. The method of claim 10, wherein the processing of the nodes of the first tree is performed using a pre-order depth-first traversal approach.

12. The method of claim 1, wherein the first tree is formed from a first HTML or XML document.

13. The method of claim 1, further comprising forming a document based on the second tree.

14. A computer program product comprising a computer readable storage medium having program instructions embodied therewith, the program instructions executable by a device to cause the device to perform a method comprising:
for each node in the first tree, determining if the node meets at least one predetermined node type rule; and
dependent at least on a result of the determining, including the node in the second tree.

15. A data processing apparatus comprising at least one processor and at least one memory having a processing module stored thereon, wherein the at least one processor with the memory and the processing module are configured to perform the steps comprising:
for each node in the first tree, determining if the node meets at least one predetermined node type rule; and
dependent at least on a result of the determining, including the node in the second tree.
